(19) United States
(12) Patent Application Publication
(10) Pub. No.: US 2023/0218999 A1
(43) Pub. Date: Jul. 13, 2023

(54) INFORMATION CONTROL METHOD AND APPARATUS IN GAME, AND ELECTRONIC DEVICE

(71) Applicant: NETEASE (HANGZHOU) NETWORK CO., LTD., Hangzhou, Zhejiang (CN)

(72) Inventor: Zhaoda HE, Hangzhou, Zhejiang (CN)

(73) Assignee: NETEASE (HANGZHOU) NETWORK CO., LTD., Hangzhou, Zhejiang (CN)

(21) Appl. No.: 18/000,825

(22) PCT Filed: Jan. 29, 2021
(86) PCT No.: PCT/CN2021/074433

§ 371 Date: Dec. 6, 2022

(30) Foreign Application Priority Data
Sep. 7, 2020 (CN) 202010932751.2

(51) Int. Cl. A63F 13/55; A63F 13/52; A63F 13/533

(52) U.S. Cl. CPC A63F 13/55; A63F 13/52; A63F 13/533; A63F 13/803

(57) ABSTRACT

A method for information control in a game includes: in response to an occlusion object triggering event, displaying an occlusion object in a first graphical user interface and a second graphical user interface, wherein the occlusion object is used for blocking at least a part of a first game scenario screen and at least a part of a second game scenario screen; in response to an elimination operation for the occlusion object, generating a first occlusion object elimination instruction; and sending the first occlusion object elimination instruction to a second terminal device, so as to eliminate at least a part of the occlusion object displayed in the second graphical user interface.

### CROSS REFERENCE

The present application is a National Stage of International Application No. PCT/CN2021/074433 filed on Jan. 29, 2021 which claims priority to Chinese Patent Application No. 202010932751.2 entitled “Method for information control in a game, an apparatus and an electronic device”, filed on Sep. 7, 2020, and both the entire contents of which are incorporated herein by reference.

### TECHNICAL FIELD

The present disclosure relates to the field of games, and in particular, to a method for information control in a game, an apparatus and an electronic device.

### BACKGROUND

For some specific types of games, such as a racing game, the game is limited by the game mechanism, the interactivity between game players may be poor, and it is difficult to generate a strong cooperation relationship between the players, so that the game experience brought to the players by the game is like playing a single-machine game.

### SUMMARY

According to a first aspect of the present disclosure, there is provided a method for information control in a game, where a first graphical user interface is provided by a first terminal device, the first graphical user interface includes a first game scenario screen; the first game scenario screen matches with a second game scenario screen included in a second graphical user interface provided by a second terminal equipment, and the method includes: displaying an occlusion object in the first graphical user interface and the second graphical user interface in response to an occlusion object triggering event, where the occlusion object is used for blocking at least a part of the first game scenario screen and at least a part of the second game scenario screen; generating a first occlusion object elimination instruction in response to an elimination operation for the occlusion object; and sending the first occlusion object elimination instruction to the second terminal device, so as to eliminate at least the part of the occlusion object displayed in the second graphical user interface.

According to a second aspect of the present disclosure, there is provided an electronic device, including a processor and a memory, where the memory stores with a machine-executable instruction capable of being executed by the processor, and the processor executes the machine-executable instruction to implement the method for information control in the game.

According to a third aspect of the present disclosure, there is provided a non-transitory machine-readable storage medium, where the machine-readable storage medium stores with a machine-executable instruction, when invoked and executed by a processor, the machine-executable instruction enables the processor to implement the method for information control in the game.

### BRIEF DESCRIPTION OF THE DRAWINGS

In order to illustrate the specific embodiments of the present disclosure or the technical solutions in the related art more clearly, the drawings to be used in the detailed implementations or the description of the related art are briefly described below. It is obvious that the accompanying drawings in the following description are some embodiments of the present disclosure, and for those skilled in the art, other drawings may be obtained according to these drawings without involving any inventive effort.

FIG. 1 is a flowchart of a method for information control in a game according to an embodiment of the present disclosure;

FIG. 2 is a schematic diagram of a graphical user interface according to an embodiment of the present disclosure;

FIG. 3 is a schematic diagram of an occlusion object in a graphical user interface according to an embodiment of the present disclosure;

FIG. 4 is another schematic diagram of occlusion object in a graphical user interface according to an embodiment of the present disclosure;

FIG. 5 is a schematic diagram of eliminating an occlusion object in a graphical user interface according to an embodiment of the present disclosure;

FIG. 6 is another schematic diagram of eliminating an occlusion object in a graphical user interface according to an embodiment of the present disclosure;

FIG. 7 is another schematic diagram of eliminating an occlusion object in a graphical user interface according to an embodiment of the present disclosure;

FIG. 8 is a schematic diagram of a specified area in a graphical user interface according to an embodiment of the present disclosure;

FIG. 9 is a schematic structural diagram of an apparatus for information control in a game according to an embodiment of the present disclosure;

FIG. 10 is a schematic structural diagram of an electronic device according to an embodiment of the present disclosure.

### DETAILED DESCRIPTION

In order to make the objects, technical solutions and advantages of the embodiments of the present disclosure clearer, the technical solutions of the present disclosure will be clearly and completely described below with reference to the accompanying drawings, and obviously, the described embodiments are some embodiments of the present disclosure rather than all embodiments. All other embodiments obtained by those skilled in the art based on the embodiments of the present disclosure without creative efforts shall fall within the protection scope of the present disclosure.

In the related art, the interaction modes between the game players are limited to, supporting, liking or sending message between players. The players can also interact with each other through the set game actions. These interaction modes are very limited, and the sense of participation and interaction between players is weak. For example, the cooperation mode between players in a game is generally implemented by some prop interaction, voice, text and the like in the game, which belongs to a relatively regular mode of communication and interaction, with various patterns, but high repetition degree and insufficient innovativeness. For example, in a racing game, teammate players may give support to each other, or send information for interaction, the interaction mode is common and lacks novelty, and the player also lacks a sense of participation. In addition, game actions, such as a “hand-pulling” “dry cup” and “smooth chat” etc., may also be set in advance. The players retrieve data of a specified game action by means of a UI (User Interface, user interface) to implement interaction with each other, but this interaction mode is not real or real-time, and the sense of participation and sense of form of the players to perform these interactions is weak.

Based on the above, there is provided a method for information control in a game, an apparatus and an electronic device according to embodiments of the present disclosure, which can be applied to player interaction in various game scenes, and particularly to racing games or other games of player cooperation. In order to facilitate understanding of the present embodiment, firstly, a method for information control in a game disclosed in the embodiments of the present disclosure is described in detail.

The method for information control in the game in an embodiment of the present disclosure may be performed on a terminal device or a server. The terminal device may be a local terminal device. When the method for information control in the game is performed on a server, the method may be implemented and executed based on a cloud interaction system, where the cloud interaction system includes a server and a client device.

In some embodiments, various cloud applications may run in the cloud interaction system, for example, a cloud game. Taking a cloud game as an example, a cloud game refers to a game mode based on cloud computing. In the running mode of the cloud game, the running body of the game program and the game screen presentation body are separated, the storage and running of the method for information control in the game are completed on the cloud game server, and the function of the client device is to receive and send data and display game screen. For example, the client device may be a display device having a data transmission function close to the user side, such as a mobile terminal, a television, a computer, a palm computer, etc. However, the terminal device for performing information processing is a cloud game server of the cloud. When a game is performed, the player operates the client device to send an operation instruction to the cloud game server, the cloud game server runs the game according to the operation instruction, encodes and compresses the data such as the game screen, returns the game screen to the client device through a network, and finally decodes and outputs the game screen through the client device.

In some embodiments, the terminal device may be a local terminal device. Taking a game as an example, a local terminal device stores with a game program and is used for presenting a game screen. The local terminal device is configured to interact with the player through a graphical user interface, that is, conventionally downloading and installing the game program through the electronic device and running it. The mode in which the local terminal device provides the graphical user interface to the player may include a variety of modes, for example, may be rendered on a display screen of the terminal, or provided to the player by holographic projection. For example, the local terminal device may include a display screen and a processor, the display screen is configured to present a graphical user interface, the graphical user interface includes a game screen, and the processor is configured to run the game, generate a graphical user interface, and control the display of the graphical user interface on the display screen.

In some embodiments, the embodiments of the present disclosure provide a method for information control in a game, in which: a first graphical user interface is provided by a first terminal device, the first graphical user interface includes a first game scenario screen; the first game scenario screen matches with a second game scenario screen included in a second graphical user interface provided by a second terminal device. Among them, the first terminal device may be the aforementioned local terminal device or a client device in the aforementioned cloud interaction system; similarly, the second terminal device may be the aforementioned local terminal device, or may be a client device in the aforementioned cloud interaction system.

It should be noted that the method for information control in the game provided in the embodiment may be implemented by the interaction between the first terminal device and the second terminal device; the first graphical user interface provided by the first terminal device includes a first game scenario screen, the first game scenario screen may include a game scene under a specified viewing angle, or may include a virtual object, and the virtual object may be a virtual conveyance, such as a virtual vehicle; the virtual object may also be a virtual character corresponding to the player, and the first game scenario screen is continuously changed along with the movement of the virtual object.

The second game scenario screen included in the second graphical user interface provided by the second terminal device matches with the first game scenario screen on the first terminal device. In actual implementation, the second game scenario screen may be the same as the first game scenario screen, or may have a relatively fixed viewing angle difference. In a specific example, the first terminal device and the second terminal device may correspond to a same virtual object jointly, and movement of the virtual object may be controlled by the first terminal device or the second terminal device, or may be jointly controlled by the first terminal device and the second terminal device; and as the virtual object moves in the game scene, the first game scenario screen and the second game scenario screen are changed accordingly.

For ease of understanding, a specific example is described here. The first game scenario screen includes a game scenario screen under a viewing angle of a first character; the second game scenario screen includes a game scenario screen under a viewing angle of a second character; and the first character and the second character correspond to the same virtual object. The first character and the second character are partnership to jointly control or manage the virtual object, but generally the first character and the second character have different labor division. In a racing game, the virtual object may be a virtual vehicle, and the first character and the second character jointly control the virtual vehicle, for example, the first character is responsible for eliminating an obstacle, and the second character is responsible for driving the virtual vehicle. Therefore, the viewing angle of the first character may be the viewing angle of the secondary driving position, and the viewing angle of the second character may be the viewing angle of the primary driving position.

Based on the foregoing, in some embodiments, the first game scenario screen and the second game scenario screen have a preset viewing angle difference; the viewing angle difference includes a viewing angle difference between the viewing angle of the first character and the second character viewing angle; for example, when the viewing angle of the first character is the viewing angle of the auxiliary driving position and the viewing angle of the second character is the viewing angle of the main driving position, the viewing angle difference of the both is the position difference between the auxiliary driving position and the main driving position. In some embodiments, considering that the viewing angle difference between the viewing angle of the first character and the viewing angle of the second character is small, setting the viewing angle difference between the first game scenario screen and the second game scenario screen has little significant, and the first game scenario screen can be directly set to be the same as the second game scenario screen.

In the racing game, the second terminal device may control the virtual object to move in the game scene according to the received operation instruction; the second terminal device corresponds to the second character, and the second character may be a driver character, or may be referred to as a racing character of the racing car; and the second character is mainly configured to control the movement of the virtual object. The first terminal device corresponds to a first character, the first character may specifically be a navigator character, and the first character is mainly configured to perform an operation of removing an obstacle, and is further configured to perform a pilot operation, or other operations to assist the first character.

In response to the movement of the virtual object in the game scene, the first game scenario screen and the second game scenario screen are adjusted at the same time. During the movement of the virtual object, no matter whether the first game scenario screen and the second game scenario screen are the same or not, both the first game scenario screen and the second game scenario screen are synchronously changed. When the first character executes the elimination operation of the obstacle on the first terminal device, the obstacle on the second terminal device is also eliminated immediately; that is, the navigator is responsible for executing the elimination operation of the obstacle and assisting in eliminating the obstacle in the game scenario screen of the driver. Similarly, when the second character executes the elimination operation of the obstacle on the second terminal device, the obstacle on the first terminal device is also eliminated immediately, that is, the driver may also perform the elimination operation of the obstacle, and at the same time assist in eliminating the obstacle in the game scenario screen of the navigator.

In some embodiments, the game scenario screen displayed in the first graphical user interface is the same as the game scenario screen displayed in the second graphical user interface. That is, when the virtual object moves in the game scene, the first game scenario screen displayed in the first graphical user interface and the second game scenario screen displayed in the second graphical user interface are continuously adjusted according to the movement of the virtual object, and the adjustment modes are the same, so that the first game scenario screen displayed in the first graphical user interface is the same as the second game scenario screen displayed in the second graphical user interface. The game scenario screen may be understood as a game screen content displayed on the first graphical user interface or the second graphical user interface other than each operable control, and the screen content may include a game scene, a virtual object, and the like. In addition, the player in the embodiment may also be referred to as a user.

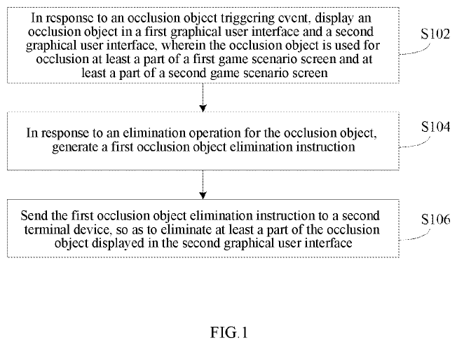

As shown in FIG. 1, the method for information control in the game includes the following steps.

In step S102, in response to an occlusion object triggering event, an occlusion object is displayed in the first graphical user interface and the second graphical user interface, where the occlusion object is used for blocking at least a part of the first game scenario screen and at least a part of the second game scenario screen.

The occlusion object trigger event may be actively triggered by the system, that is, the occlusion object trigger event may be triggered when the system reaches certain conditions objectively, or may be triggered during the player interaction process. When the first terminal device or the second terminal device controls the virtual object to move in the game scene, a plurality of positions in the game scene may be reached, and therefore, the occlusion object triggering event can be set based on the position of the virtual object. Weather or climate in the game scene may also continuously change, and therefore, the occlusion object triggering event can be set based on the weather where the virtual object is currently located; the occlusion object triggering event set based on the position and the weather can be understood as an occlusion object triggering event actively triggered by the system; and in addition, when the virtual object is implemented by other players with props related to the occlusion object, the occlusion object triggering event can also be triggered.

After the blocking object triggering event is triggered, the occlusion object is displayed in the first graphical user interface and the second graphical user interface, and the occlusion object may be determined according to the specific type of the occlusion object triggering event; for example, the occlusion object may be fog, muddy water, leaves, etc. In a racing game, the occlusion object may be simulated to fall on the virtual vehicle glass. The display priority of the occlusion object is higher than that of the game scenario screen, and at this time, the occlusion object can block the player from watching the game scenario screen. The occlusion object can block a part of the game scenario screen, and can also block the entire game scenario screen; the occlusion object can also have specific transparency, and when the transparency is high, the player can still watch the game scenario screen through the occlusion object, but the definition is reduced; and when the transparency is low, the player is difficult to watch the game scenario screen through the occlusion object.

After the blocking object triggering event is triggered, an occlusion object may appear on the first graphical user interface and the second graphical user interface simultaneously, and therefore, the occlusion object may block at least a part of the first game scenario screen and at least a part of the second game scenario screen at the same time. The size, position, and the like of the occlusion object in the first graphical user interface and the second graphical user interface may be the same or different.

In step S104, a first occlusion object elimination instruction is generated in response to an elimination operation for the occlusion object.

In step S106, the first occlusion object elimination instruction is sent to the second terminal device to eliminate at least a part of the occlusion object displayed in the second graphical user interface.

For the player of the first terminal device, the occlusion object blocks the first game scenario screen, the player can perform an elimination operation on the occlusion object, and the elimination operation can be a sliding operation to simulate a wiping action of the occlusion object, or can also be a click operation to simulate a cleaning action of the occlusion object. In most cases, after the elimination operation for the occlusion object occurs, the occlusion object in the first graphical user interface provided by the first terminal device may be completely or partially eliminated.

In some embodiments, in order to improve the interactivity between the player of the first terminal device and the player of the second terminal device, after the player triggers the elimination operation, in addition to eliminating the occlusion object in the first graphical user interface provided by the first terminal device, the first occlusion object elimination instruction can be generated based on the elimination operation, the first occlusion object elimination instruction is sent to the second terminal device, and after the second terminal device receives the elimination instruction, at least a part of the occlusion object displayed in the second graphical user interface is eliminated. In this way, the player of the first terminal device may assist the player of the second terminal device in eliminating the occlusion object. The above-mentioned first occlusion object elimination instruction is generated based on the elimination operation of the player of the first terminal device, and therefore, in the elimination process of the occlusion object in the second graphical user interface, the eliminated position, path and the like can be the same as or correspond to the position, path and the like of the occlusion object on the first terminal device. At this time, the player of the second terminal device can truly feel that the player of the first terminal device helps to eliminate the occlusion object, and the sense of reality and sense of interaction between the two players is higher.

In the method for information control in the game, after the occlusion object triggering event is triggered, the occlusion object is displayed in the first graphical user interface and the second graphical user interface, and after the player of the first terminal device triggers the elimination operation for the occlusion object, a first occlusion object elimination instruction is generated and sent to the second terminal device to eliminate at least a part of the occlusion object displayed in the second graphical user interface. In this way, the interactivity between game players can be enriched, the cooperation interaction tightness between players is improved, the sense of reality and sense of interaction between players are high, and the game experience is high.

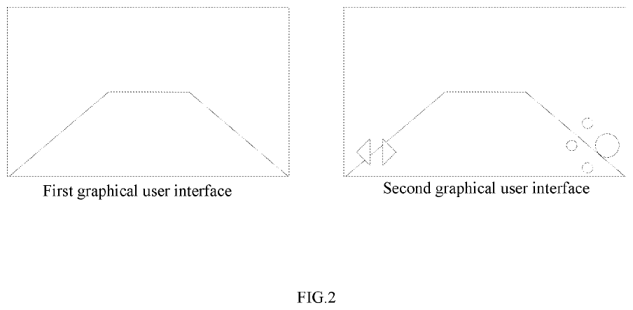

In some embodiments, when the player of the first terminal device and the player of the second terminal device perform a cooperative game, the first game scenario screen displayed in the first graphical user interface is the same as the second game scenario screen displayed in the second graphical user interface. The game scenario screen may include a game scene, a game special effect, and the like. The first game scenario screen and the second game scenario screen may be displayed synchronously and consistently. In addition to the game scenario screen, the graphical user interface may further include a user operation control, and the user operation controls in the first graphical user interface and in the second graphical user interface may be the same or different. As an example of FIG. 2, the first game scenario screen and the second game scenario screen are the same, but the user operation controls in the first graphical user interface and the second graphical user interface are different.

The above occlusion object trigger event may be triggered by one of the following manners: in a first manner, the virtual object moves to a specified position in the game scene, the specified position may be a road section with water, mud, leaves, etc., and when the virtual object passes through the specified position, water, mud, leaves, or other virtual objects may be splashed, thereby triggering the occlusion object triggering event; in a second manner, the virtual weather in the game scene where the virtual object is currently located is a specified weather type, and the specified weather type may be foggy day, haze day, rainy day, etc., the virtual weather may be preset with multiple weather types performing transformation based on a specified sequence, may also be associated with the position of the game scene, and different positions correspond to different weather types; in a third manner, ae specified prop is triggered and acts on the virtual object, the specified prop may be a smoke cartridge, a water spray gun, or the like, other players may trigger the specified prop and act on the virtual object, and at this time, the occlusion object trigger event may be triggered. By setting the plurality of triggering modes of the occlusion object triggering event, the occlusion object triggering event can be triggered in different scenes, and the richness of game interaction is improved.

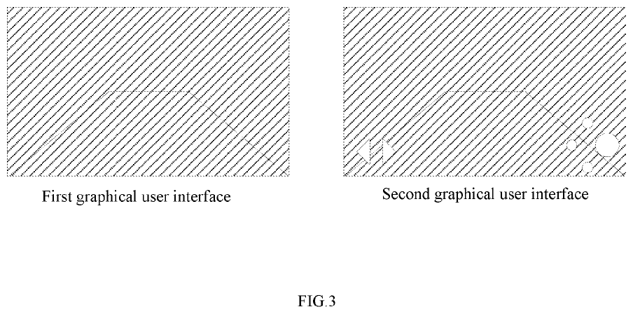

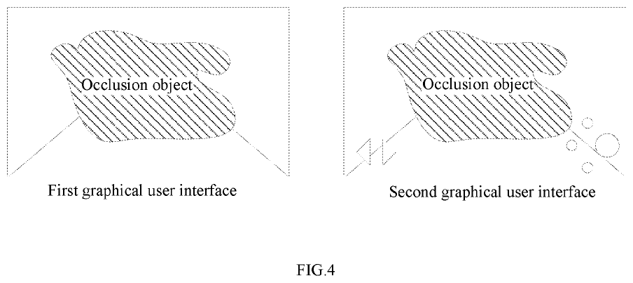

After the occlusion object triggering event is triggered, the occlusion object is displayed in both the first graphical user interface and the second graphical user interface, and in some embodiments, the occlusion object displayed in the first graphical user interface and the second graphical user interface has a preset viewing angle difference; and the viewing angle difference may be specifically a viewing angle difference between the viewing angle of the first character and the second character viewing angle. For example, when the viewing angle of the first character is the viewing angle of the auxiliary driving position and the viewing angle of the second character is the viewing angle of the main driving position, the viewing angle difference between them is the position difference between the auxiliary driving position and the main driving position. In some embodiments, considering that the viewing angle difference between the viewing angle of the first character and the second character viewing angle is small and negligible, the occlusion object displayed in the first graphical user interface and the second graphical user interface is the same. In this way, the view of the player of the first terminal device may be simulated to be the same as that of the second terminal device, for example, the first terminal device and the second terminal device correspond to the same virtual object, or a same riding conveyance is ride, thereby improving the cooperative interaction feeling of the two players. As shown in FIG. 3, the occlusion object in the first graphical user interface and the second graphical user interface block the entire game scenario screen, and the transparency is low, which seriously affects the view of the player watching the game scenario screen; and generally, the occlusion object does not block the user operation control. As another example in FIG. 4, the occlusion object in the first graphical user interface and the second graphical user interface block a part of the game scenario screen.

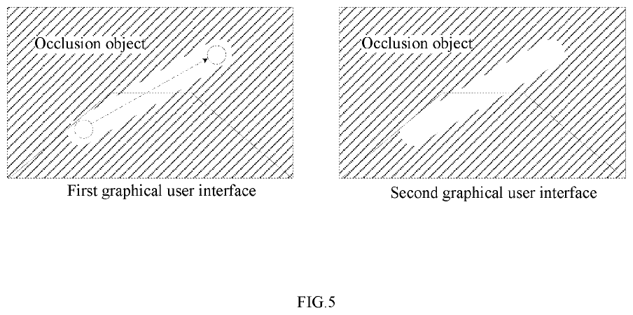

When the elimination operation of the occlusion object is different, the generated first occlusion object elimination instruction is also different. In one embodiment, the elimination operation is a sliding operation, and when a player of the first terminal device performs a sliding operation on the first terminal device, a part of the occlusion object is eliminated immediately; As an example in FIG. 5, the circle of dotted line is the starting position of the player finger, the finger moves in the direction of the dotted arrow, the occlusion object near the finger is eliminated immediately in the moving process, the circle of real line is the end point position of the player finger, and the sliding operation can be realized by the player through a single finger sliding or a multi-finger sliding. At this time, the occlusion object within the white strip-shaped blank area is eliminated, and it can be understood that the area where the occlusion object is eliminated and the occlusion object area are mutually exclusive areas. Certainly, the sliding track of the sliding operation may be in various shapes, and the shape of the area where the occlusion object is eliminated is not limited.

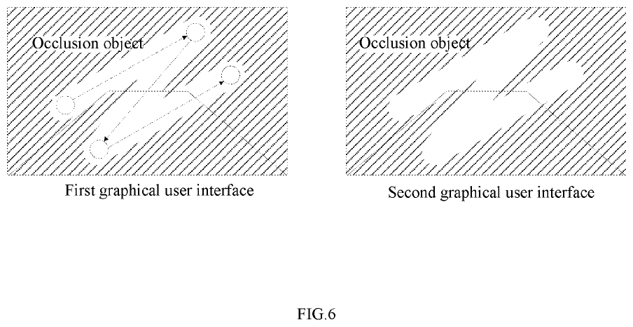

When the player performs a sliding operation, in response to a sliding operation acting on the occlusion object, a first occlusion object elimination instruction is generated, where the sliding operation is used for indicating to eliminate at least a part of the occlusion object. When the sliding operation acts on the occlusion object, the occlusion object is immediately eliminated, and the position of the eliminated occlusion object is related to the position of the sliding operation. When the occlusion object area is relatively smaller, the path of the sliding operation may be short and the time consumption is shorter, and at this time, after the sliding operation is completed, the first occlusion object elimination instruction can be generated; when the occlusion object area is relatively larger, the path of the sliding operation performed by the player may be longer, and a long time needs to be spent, and in order to keep the real-time performance of the content in the graphical user interface on the first terminal device and the second terminal device, a threshold may be preset, the threshold may be a path length threshold or a time consumption threshold, and when the sliding operation satisfies the threshold, a first occlusion object elimination instruction is generated, and every time when the subsequent sliding operation reaches the threshold, a first occlusion object elimination instruction is generated, which can keep the elimination state of the occlusion object on the first terminal device and the second terminal device relatively synchronized, as shown in FIG. 5. As another example in FIG. 6, when the occlusion object area is relatively larger, the path of the sliding operation may be longer, and during the execution of the sliding operation, a plurality of first occlusion object elimination instructions may be sequentially generated until the sliding operation ends.

When the first occlusion object elimination instruction is generated, one specific implementation mode is: in response to a sliding operation acting on the occlusion object, obtaining a target position passing by the sliding operation on the occlusion object; generating a first occlusion object elimination instruction based on the target position, where the first occlusion object elimination instruction is used for indicating to: eliminate the occlusion object at the target position and the occlusion object within a preset range from the target position.

In the first terminal device, the occlusion object at the target position passing by the sliding operation is eliminated, and if the occlusion object area is large or the player finger is thinner, in order to prevent the player from performing a long path or a long-time sliding operation, a range threshold can be set, the occlusion object in the preset range from the target position is eliminated while the occlusion object at the target position is eliminated, and the convenience of the player operation is improved. When the player performs a sliding operation, the system may record a target position passing by the sliding operation on the occlusion object, and the position coordinates of the target position may be carried in the first occlusion object elimination instruction, so that the second terminal device also eliminates the occlusion object at the target position, realizing that the state of the occlusion object eliminated on the first terminal device and the second terminal device is the same. When the second terminal device executes the first occlusion object elimination instruction, in addition to eliminating the occlusion object at the target position, the occlusion object within the preset range from the target position is also eliminated.

Another implementation of the elimination operation is a click operation, and a first occlusion object elimination instruction is generated in response to a click operation acting on the occlusion object; the click operation is used for indicating to delete at least a part of the occlusion object. In the first terminal device, when the player performs a click operation, the position where the finger is located, that is, the position where the occlusion object is eliminated, and the occlusion object in the surrounding area of the position where the finger is located may also be eliminated.

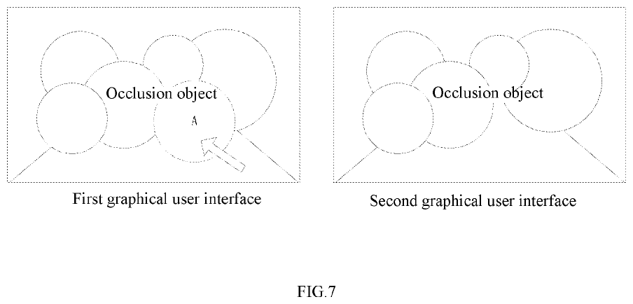

Eliminating the occlusion object with a clicking operation can be applied to the occlusion object with a state of continuous substance. As shown in FIG. 5 or FIG. 6, in most cases, the click operation to eliminate the occlusion object is more suitable for the situation that the occlusion object is a discrete virtual substance, and at this time, the graphical user interface may include a plurality of occlusion objects, and each occlusion object is eliminated by clicking one by one. As shown in FIG. 7, the graphical user interface includes a plurality of circular occlusion objects. When the occlusion object is a plurality of discrete occlusion objects, elimination can also be performed through the sliding operation.

In some embodiments, in response to a click operation acting on the occlusion object, a target occlusion object acted by the click operation is obtained; a first occlusion object elimination instruction is generated based on the target occlusion object; the first occlusion object elimination instruction is used for indicating to eliminate the target occlusion object. Containing reference to FIG. 7, the arrow represents the finger of the player, and when the player performs a click operation, the target occlusion object acted by the click operation is the occlusion object A, and at this time, in the first terminal device, the occlusion object A disappears, and meanwhile, the identification of the occlusion object A is carried in the first occlusion object elimination instruction for indicating the second terminal device to eliminate the occlusion object A too.

In the process of performing the elimination operation described above, two operations are generally performed in response to an elimination operation for the occlusion object, one operation is to generate a first occlusion object elimination instruction, and another operation is to eliminate at least a part of the occlusion object in the first graphical user interface. The two operations can be executed at the same time to ensure that the occlusion object on the first terminal device and the second terminal device are eliminated at the same time; at this time, at least a part of the occlusion object eliminated in the first graphical user interface is the same as at least a part of the occlusion object eliminated in the second graphical user interface, so that the cooperation interaction tightness between the players can be improved, and the sense of reality and sense of interaction between players is relatively higher. In another manner, the elimination state of the occlusion object on the second terminal device has a certain delay relative to the elimination state of the occlusion object on the first terminal device. In addition, in some specific game scenarios, the first occlusion object elimination instruction may be generated, that is, the occlusion object on the second terminal device is eliminated, and at least a part of the occlusion object in the first graphical user interface on the first terminal device is not eliminated. The specific execution manner may be set based on game scene requirements.

The first occlusion object elimination instruction is generated by the first terminal device and sent to the second terminal device, and in the process of the cooperatively gaming by the players of the first terminal device and the second terminal device, the second terminal device may also generate an occlusion object elimination instruction to eliminate the occlusion object on the first terminal device. That is, in response to receiving a second occlusion object elimination instruction sent by the second terminal device, the occlusion object to be eliminated indicated by the second occlusion object elimination instruction is determined; and the occlusion object to be eliminated in the first graphical user interface is eliminated. The generation manner of the second occlusion object elimination instruction may refer to the foregoing first occlusion object elimination instruction. The second occlusion object elimination instruction may carry the position or identification of the occlusion object to be eliminated, for example, the second occlusion object elimination instruction may carry the target position of the occlusion object to be eliminated, and when the occlusion object is a discrete object, the second occlusion object elimination instruction may carry the identification of the occlusion object to be eliminated. Based on this manner, the players of the first terminal device and the second terminal device may eliminate the occlusion object for each other, thereby improving the degree of cooperation and interaction between the players, and improving the cooperation efficiency and the sense of substitution of the player.

When the player performs the elimination operation, in addition to eliminating the occlusion object on the terminal device, the system may also give a reward to the player based on the elimination state of the occlusion object. Based on this, in response to an elimination operation for the occlusion object, a state of the occlusion object being eliminated is detected; it is determined that whether the state of the occlusion object being eliminated satisfies a specified condition or not; and if the specified condition is satisfied, a preset reward mechanism is triggered, where the reward mechanism includes: updating a game score of the first terminal device and/or the second terminal device, or giving a game prop specified by the first terminal device and/or the second terminal device. During actual implementation, the game scores of the first terminal device and the second terminal device may be updated at the same time, or the game score of the first terminal device or the second terminal device may be updated; and updating the game score may specifically include increasing the score by a preset number, or increasing the game score based on a preset coefficient. The reward mechanism may further be providing a specified game prop to the first terminal device and the second terminal device, or providing a specified game prop to the first terminal device or the second terminal device, and the specified game prop may have a specific function, for example, a prop for acceleration, a prop for increasing the game score, and a prop for attacking competitor, and in conclusion, the game prop is beneficial to improving the game score of the player.

The above-mentioned state of the occlusion object being eliminated may specifically be the position of the area where the occlusion object is eliminated, the size of the area, the number of the occlusion object being eliminated, and the like. The specified condition is set based on the state of the occlusion object being eliminated, and when specifically implemented, the specified condition includes one of the following:

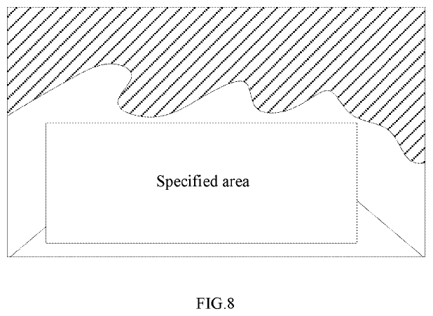

Condition 1: the area where the occlusion object is eliminated is greater than or equal to the specified area. where the specified area has a preset area shape and/or a preset area size. The specified area may have a preset area size, the area size may be measured by pixels or other units, and if the area where the occlusion object is eliminated is greater than or equal to the area size, it may be considered that the specified condition is satisfied. The specified area may have a preset area shape, such as a rectangle, a circle, or the like; if the area where the occlusion object is eliminated may contain the area shape of any size, it may be considered that the specified condition is satisfied; certainly, the specified area may have a preset area shape and area size at the same time. FIG. 8 is an example, and the specified area is a rectangle having a certain area size. When the area where the occlusion object is eliminated may contain the specified area, it may be considered that the specified condition is satisfied.

It should be noted that the specified area may have a fixed position, or may be changed in real time. When the specified area has a fixed position, the specified area may be included in the area where the occlusion object is eliminated, so that it can be considered the specified condition is satisfied; and when the position of the specified area can be changed in real time, the position of the specified area can be changed in real time to determine that whether the area of the occlusion object being eliminated can be contained in the specified area.

Condition 2: the path shape of the occlusion object being eliminated is a specified path shape; and the specified path shape may be a shape of zigzag, a shape of concentric square, a circle, etc.

Condition 3: the number of the occlusion object being eliminated is greater than or equal to the specified number. The condition is generally applicable to the condition that the occlusion object includes a plurality of discrete objects, and the specified number may be equal to the total number of the occlusion objects displayed in the graphical user interface, or may be smaller than the total number of the occlusion objects displayed in the graphical user interface.

In order to enable the elimination operation triggered by the player to satisfy the above specified condition, the operation indication information may be displayed in the first graphical user interface, where the operation indication information is used to prompt a specified condition that the occlusion object needs to be satisfied. For example, for the above condition 1, the specified area may be displayed in the graphical user interface; for the above condition 2, the specified path shape may be displayed in the graphical user interface, and for the above condition 3, the number of the occlusion object to be eliminated may be displayed in the graphical user interface, and as the player operates, the number is reduced accordingly until the number is reduced to zero, and the elimination operation satisfies the above specified conditions.

In addition, in order to improve the sense of substitution of the game player, a time parameter may be introduced. When the state of the occlusion object being eliminated satisfies the specified condition within a specified time, a corresponding reward is provided to a player of the first terminal device and/or a player of the second terminal device; and when the state of the occlusion being eliminated does not satisfy the specified condition within the specified time, the player does not be provided with a corresponding reward, and the occlusion object on the graphical user interface may be automatically eliminated.

According to the method for information control in the game, players of the first terminal device and the second terminal device cooperate to complete the game task, when one of the players eliminates the occlusion object on the terminal device, the occlusion object on the terminal device of the other player is also eliminated, so that the cooperation efficiency between the players and the sense of substitution can be improved. When the player eliminates the occlusion object, the operation path is synchronously displayed on the two terminal devices, so that the real-time performance and the interaction reality sense of player interaction are improved. In addition, in a racing game or other games in which it is needed to observe a game scene in real time, blocking the sight of the player seriously affects the game score of the player, and the cooperative players eliminate the occlusion object for each other, so that the cooperation necessity between the players can be enhanced.

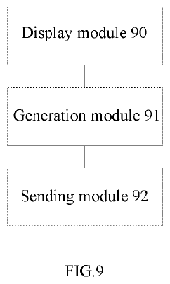

Corresponding to the foregoing method embodiments, an apparatus for information control in a game as shown in FIG. 9 is referred to, a first graphical user interface is provided by a first terminal device, and the first graphical user interface includes a first game scenario screen; the first game scenario screen matches with a second game scenario screen included in a second graphical user interface provided by the second terminal device; the apparatus includes:

a display module 90, configured to display an occlusion object in the first graphical user interface and the second graphical user interface in response to an occlusion object triggering event, where the occlusion object is used for blocking at least a part of the first game scenario screen and at least a part of the second game scenario screen.

a generation module 91, configured to generate a first occlusion object elimination instruction in response to an elimination operation for the occlusion object;

a sending module 92, configured to send the first occlusion object elimination instruction to the second terminal device to eliminate at least a part of the occlusion object displayed in the second graphical user interface.

In the apparatus for information control in a game, after the occlusion object triggering event is triggered, the occlusion object is displayed in the first graphical user interface and the second graphical user interface. After the player of the first terminal device triggers the elimination operation for the occlusion object, the first occlusion object elimination instruction is generated and sent to the second terminal device to eliminate at least a part of the occlusion object displayed in the second graphical user interface. In this way, the interactivity between game players can be enriched, the cooperation interaction tightness between players is improved, the sense of reality and sense of interaction between players are higher, and the game experience is higher.

The first game scenario screen displayed in the first graphical user interface is the same as the second game scenario screen displayed in the second graphical user interface.

The first terminal device or the second terminal device controls the virtual object to move in the game scene; the occlusion object trigger event is triggered by one of the following manners: the virtual object moving to a specified position in the game scene; the virtual weather in the game scene where the virtual object is currently located being a specified weather type; and the specified prop being triggered and acting on the virtual object.

The occlusion object displayed in the first graphical user interface and the second graphical user interface is the same.

The generating module is further configured to generate the first occlusion object elimination instruction in response to a sliding operation acting on the occlusion object, where the sliding operation is used for indicating to erase at least a part of the occlusion object.

The generating module is further configured to: in response to a sliding operation acting on the occlusion object, obtain a target position passing by the sliding operation on the occlusion object; generate a first occlusion object elimination instruction based on the target position, where the first occlusion object elimination instruction is used for indicating to eliminate the occlusion object at the target position and the occlusion object within a preset range from the target position.

The generating module is further configured to generate a first occlusion object elimination instruction in response to a click operation acting on the occlusion object, where the click operation is used for indicating to delete at least a part of the occlusion object.

The above-mentioned occlusion object includes a more than one occlusion object, and the generating module is further configured to: in response to a click operation acting on the occlusion object, obtain a target occlusion object acted by the click operation; generate a first occlusion object elimination instruction based on the target occlusion object, where the first occlusion object elimination instruction is used for indicating to eliminate the target occlusion object.

The apparatus further includes a first elimination module configured to eliminate at least a part of the occlusion object in the first graphical user interface in response to a elimination operation for the occlusion object.

At least a part of the occlusion object eliminated in the first graphical user interface is the same as at least a part of the occlusion object eliminated in the second graphical user interface.

The apparatus further includes: a second elimination module, configured to: determine, in response to receiving a second occlusion object elimination instruction sent by the second terminal device, an occlusion object to be eliminated indicated by the second occlusion object elimination instruction; and eliminate the occlusion object to be eliminated indicated in the first graphical user interface.

The apparatus further includes a rewarding module, configured to: in response to an elimination operation for the occlusion object, detect a state of the occlusion object being eliminated; determine that whether the state of the occlusion object being eliminated satisfies a specified condition or not; and if the specified condition is satisfied, trigger a preset reward mechanism, where the reward mechanism includes: updating a game score of the first terminal device and/or the second terminal device, or providing a specified game prop to the first terminal device and/or the second terminal device.

The specified condition includes one of the following: an area where the occlusion object is eliminated is greater than or equal to a specified area, where the specified area has a preset area shape and/or a preset area size; the path shape of the occlusion object being eliminated is a specified path shape; and the number of the occlusion object being eliminated is greater than or equal to a specified number.

The apparatus further includes a display module configured to display operation indication information in the first graphical user interface, where the operation indication information is used to prompt a specified condition that the occlusion object needs to be satisfied.

The present embodiment further provides an electronic device, including a processor and a memory, where the memory stores with a machine-executable instruction that can be executed by the processor, and the processor executes the machine-executable instruction to implement the above-mentioned method for information control in a game.

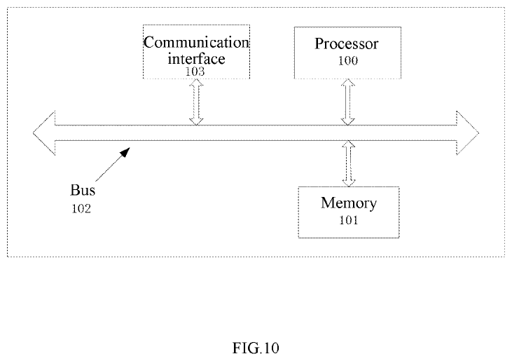

Referring to FIG. 10, the electronic device includes a processor 100 and a memory 101, the memory 101 stores with a machine-executable instruction that can be executed by the processor 100, and the processor 100 executes the machine-executable instruction to implement the method for information control in the game.

Further, the electronic device shown in FIG. 10 further includes a bus 102 and a communication interface 103. The processor 100, the communication interface 103, and the memory 101 are connected through the bus 102.

Among them, the memory 101 may include a high-speed random-access memory (RAM), or may further include a non-volatile memory, such as at least one magnetic disk memory. The communication connection between the system network element and at least one other network element may be implemented by means of the at least one communication interface 103 (which may be wired or wireless), and the Internet, a wide area network, a local network, a metropolitan area network, etc. may be used. The bus 102 may be an ISA bus, a PCI bus, or an EISA bus, or the like. The bus may be divided into an address bus, a data bus, a control bus, and the like. For ease of representation, one bidirectional arrow is used in FIG. 10 to represent, but does not mean that there is one bus or one type of bus.

The processor 100 may be an integrated circuit chip having a signal processing capability. In an implementation process, the steps of the foregoing method may be completed by an integrated logic circuit of hardware in the processor 100 or an instruction in the form of software. The processor 100 may be a general processing unit, including a central processing unit (CPU), a network processor (NP), or the like, or may be a digital signal processor (DSP), an Application Specific Integrated Circuit (ASIC), a Field-Programmable Gate Array (FPGA) or another programmable logic device, a discrete gate or a transistor logic device, and a discrete hardware component. The methods, steps, and logic block diagrams disclosed in the embodiments of the present disclosure may be implemented or performed. The general processing unit may be a microprocessor or the processor may be any conventional processor or the like. The steps of the method disclosed in connection with the embodiments of the present disclosure may be directly embodied as a hardware decoding processor for implementation, or implemented by combining hardware in a decoding processor and a software module. The software module may be located in a mature storage medium in the art, such as a random-access memory, a flash memory, a read-only memory, a programmable read-only memory or an electrically erasable programmable memory, a register, etc. The storage medium is located in the memory 101, and the processor 100 reads the information in the memory 101 and completes the steps of the method according to the foregoing embodiments in combination with hardware of the processor 100.

The present embodiment further provides a machine-readable storage medium, where the machine-readable storage medium stores with a machine-executable instruction, and when the machine-executable instruction is invoked and executed by the processor, the machine-executable instruction enables the processor to implement the above-mentioned method for information control in a game.

The computer program product of the method for information control in a game, the apparatus, and the electronic device provided in the embodiments of the present disclosure includes a computer-readable storage medium storing with a program code, where the instruction included in the program code may be used for executing the method described in the foregoing method embodiments. For specific implementations, reference may be made to the method embodiments, and details are not described here again.

The computer program product of the method for information control in a game, the apparatus, and system provided in the embodiments of the present disclosure includes a computer-readable storage medium storing with a program code, where the instruction included in the program code may be used for executing the method described in the foregoing method embodiments. For specific implementations, reference may be made to the method embodiments, and details are not described here again.

It can be clearly understood by those skilled in the art that, for the convenience and brevity of description, the specific working process of the system and device described above can refer to the corresponding processes in the foregoing method embodiments, and details are not described here again.

In addition, in the description of the embodiments of the present disclosure, unless otherwise specified and restricted, the terms “mounting”, “connected” and “connecting” shall be construed broadly, for example, may be a fixed connection, a detachable connection, or an integrated connection; it may be a mechanical connection or an electrical connection; it may be directly connected or indirectly connected by an intermediate medium, and may be a communication between two elements. For those skilled in the art, the specific meaning of the above terms in the present disclosure may be understood specifically.

When the functions are implemented in the form of a software functional unit and sold or used as an independent product, it may be stored in a computer-readable storage medium. Based on such understanding, the technical solution of the present disclosure or the part contributing to the related art or the part of the technical solution can be embodied in the form of a software product in essence, and the computer software product is stored in a storage medium, and includes several instructions for enabling a computer device (which may be a personal computer, a server, or a network device, etc.) to perform all or part of the steps of the method according to various embodiments of the present disclosure. The foregoing storage medium includes various media that can store program codes, such as a USB flash disk, a mobile hard disk, a read-only memory (ROM), a random access memory (RAM), a magnetic disk, or an optical disc.

In the description of the present disclosure, it should be noted that the orientation or positional relationship indicated by the terms “center,” “upper,” “lower,” “left,” “right,” “vertical,” “horizontal,” “inner,” “outer,” and the like is based on the orientation or positional relationship shown in the drawings, just for the convenience of describing the disclosure and simplifying the description, rather than indicating or implying that the indicated device or element must have a specific orientation, constructed and operated in a specific orientation, and therefore cannot be understood as a limitation to the present disclosure. In addition, the terms “first”, “second” and “third” are used for descriptive purposes and cannot be understood as indicating or implying relative importance.

Finally, it should be noted that: the above embodiments are merely specific embodiments of the present disclosure for illustrating the technical solutions of the present disclosure without limitation, and the scope of protection of the present disclosure is not limited to this. Although the present disclosure is described in detail with reference to the foregoing embodiments. Those skilled in the art should understand that: any person skilled in the art can still modify or easily conceive of modifying the technical solutions recited in the foregoing embodiments, or equivalently replace some of the technical features in the technical scope disclosed in the present disclosure, and these modifications, changes or substitutions do not make the nature of the corresponding technical solutions depart from the spirit and scope of the technical solutions of the embodiments of the present disclosure, all of which should be covered within the scope of protection of the present disclosure. Therefore, the protection scope of the present disclosure shall be subject to the protection scope of the claims.

1. A method for information control in a game, wherein a first graphical user interface is provided by a first terminal device, the first graphical user interface comprises a first game scenario screen; the first game scenario screen matches with a second game scenario screen comprised in a second graphical user interface provided by a second terminal equipment, and the method comprises:
displaying an occlusion object in the first graphical user interface and the second graphical user interface in response to an occlusion object triggering event, wherein the occlusion object is used for blocking at least a part of the first game scenario screen and at least a part of the second game scenario screen;
generating a first occlusion object elimination instruction in response to an elimination operation for the occlusion object; and
sending the first occlusion object elimination instruction to the second terminal device, so as to eliminate at least the part of the occlusion object displayed in the second graphical user interface.

2. The method according to claim 1, wherein the first game scenario screen comprises a game scenario screen under a viewing angle of a first character, the second game scenario screen comprises a game scenario screen under a viewing angle of a second character, and the first character and the second character correspond to a same virtual object.

3. The method according to claim 2, wherein a preset viewing angle difference is provided between the first game scenario screen and the second game scenario screen; the viewing angle difference comprises a viewing angle difference between the viewing angle of the first character and the viewing angle of the second character; or
the first game scenario screen is the same as the second game scenario screen.

4. The method according to claim 2, wherein the virtual object is controlled by the second terminal device to move in a game scene according to a received operation instruction; and in response to movement of the virtual object in the game scene, the first game scenario screen and the second game scenario screen are adjusted simultaneously.

5. The method according to claim 4, wherein the occlusion object triggering event comprises one of the following:
the virtual object moves to a specified position in the game scene;
virtual weather in the game scene where the virtual object is currently located is a specified weather type; or
a specified prop is triggered and acts on the virtual object.

6. The method according to claim 2, wherein the occlusion object displayed in the first graphical user interface and the second graphical user interface is the same; or
a preset viewing angle difference is provided between the occlusion object displayed in the first graphical user interface and the occlusion object displayed in the second graphical user interface; and the viewing angle difference comprises a viewing angle difference between the viewing angle of the first character and the viewing angle of the second character.

7. The method according to claim 1, wherein the step of generating the first occlusion object elimination instruction in response to the elimination operation for the occlusion object comprises:
generating, in response to a sliding operation acting on the occlusion object, the first occlusion object elimination instruction, wherein the sliding operation is used for indicating to eliminate at least a part of the occlusion object.

8. The method according to claim 7, wherein, the step of generating the first occlusion object elimination instruction in response to the sliding operation acting on the occlusion object comprises:
obtaining, in response to the sliding operation acting on the occlusion object, a target position passing by the sliding operation on the occlusion object; and
generating the first occlusion object elimination instruction based on the target position, wherein the first occlusion object elimination instruction is used for indicating to eliminate the occlusion object at the target position and the occlusion object within a preset range from the target position.

9. The method according to claim 1, wherein the step of generating the first occlusion object elimination instruction in response to the elimination operation for the occlusion object comprises:
generating, in response to a click operation acting on the occlusion, the first occlusion object elimination instruction, wherein the click operation is used for indicating to delete at least a part of the occlusion object.

10. The method of claim 9, wherein the occlusion object comprises more than one occlusion object, and the step of generating the first occlusion object elimination instruction in response to the click operation acting on the occlusion object comprises:
obtaining, in response to a click operation acting on the occlusion object, a target occlusion object acted by the click operation; and
generating the first occlusion object elimination instruction based on the target occlusion object, wherein the first occlusion object elimination instruction is used for indicating to eliminate the target occlusion object.

11. The method of claim 1, wherein the method further comprises:
eliminating, in response to an elimination operation for the occlusion, at least the part of the occlusion object in the first graphical user interface.

12. The method according to claim 11, wherein at least the part of the occlusion object eliminated in the first graphical user interface is the same as at least the part of the occlusion object eliminated in the second graphical user interface.

13. The method according to claim 1, wherein the method further comprises:
determining, in response to a second occlusion object elimination instruction sent by the second terminal device, an occlusion object to be eliminated indicated by the second occlusion object elimination instruction; and
eliminating the occlusion object to be eliminated in the first graphical user interface.

14. The method of claim 1, wherein the method further comprises:
detecting, in response to an elimination operation for the occlusion object, a state of the occlusion object being eliminated; and
in response to determining that the state of the occlusion object being eliminated satisfies a specified condition, triggering a preset reward mechanism, wherein the reward mechanism comprises updating a game score of the first terminal device and/or the second terminal device, or providing a specified game prop to the first terminal device and/or the second terminal device.

15. The method according to claim 14, wherein the specified condition comprises one of:
an area of the occlusion object being eliminated is greater than or equal to a specified area, wherein the specified area is provided with a preset area shape and/or a preset area size;
a path shape of the occlusion object being eliminated is a specified path shape; or
a number of the occlusion object being eliminated is greater than or equal to a specified number.

16. The method according to claim 1, wherein the method further comprises:
displaying operation indication information in the first graphical user interface, wherein the operation indication information is used for prompting a specified condition required to be satisfied by a state of the occlusion object being eliminated.

17. (canceled)

18. An electronic device, comprising a processor and a memory, wherein the memory stores with a machine-executable instruction capable of being executed by the processor, and the processor executes the machine-executable instruction to implement a method for information control in a game, wherein a first graphical user interface is provided by a first terminal device, the first graphical user interface comprises a first game scenario screen; the first game scenario screen matches with a second game scenario screen comprised in a second graphical user interface provided by a second terminal equipment, and the method comprises:
displaying an occlusion object in the first graphical user interface and the second graphical user interface in response to an occlusion object triggering event, wherein the occlusion object is used for blocking at least a part of the first game scenario screen and at least a part of the second game scenario screen;
generating a first occlusion object elimination instruction in response to an elimination operation for the occlusion object; and
sending the first occlusion object elimination instruction to the second terminal device, so as to eliminate at least the part of the occlusion object displayed in the second graphical user interface.

19. A non-transitory machine-readable storage medium, wherein the machine-readable storage medium stores with a machine-executable instruction, when invoked and executed by a processor, the machine-executable instruction enables the processor to implement a method for information control in a game, wherein a first graphical user interface is provided by a first terminal device, the first graphical user interface comprises a first game scenario screen; the first game scenario screen matches with a second game scenario screen comprised in a second graphical user interface provided by a second terminal equipment, and the method comprises:
displaying an occlusion object in the first graphical user interface and the second graphical user interface in response to an occlusion object triggering event, wherein the occlusion object is used for blocking at least a part of the first game scenario screen and at least a part of the second game scenario screen;
generating a first occlusion object elimination instruction in response to an elimination operation for the occlusion object; and
sending the first occlusion object elimination instruction to the second terminal device, so as to eliminate at least the part of the occlusion object displayed in the second graphical user interface.

20. The non-transitory machine-readable storage medium according to claim 19, wherein the method further comprises:
eliminating, in response to an elimination operation for the occlusion, at least the part of the occlusion object in the first graphical user interface.

21. The non-transitory machine-readable storage medium according to claim 19, wherein the method further comprises:
determining, in response to a second occlusion object elimination instruction sent by the second terminal device, an occlusion object to be eliminated indicated by the second occlusion object elimination instruction; and
eliminating the occlusion object to be eliminated in the first graphical user interface.
